(19) United States
(12) Patent Application Publication
(10) Pub. No.: US 2026/0316482 A1
(43) Pub. Date: Oct. 15, 2026

(54) SECURITY ELEMENT, VALUABLE DOCUMENT AND METHOD FOR MANUFACTURING A SECURITY ELEMENT

(71) Applicant: Giesecke+Devrient Currency Technology GmbH, Munich (DE)

(72) Inventors: Alessandro PARISOTTO, Gmund am Tegernsee (DE); Matthias BLAZEK, Gmund am Tegernsee (DE); Christian STOECKL, Gmund am Tegernsee (DE)

(21) Appl. No.: 19/642,964

(22) Filed: Apr. 9, 2026

(30) Foreign Application Priority Data
Apr. 15, 2025 (EP) 25170830.1

(51) Int. Cl. B42D 25/324; B42D 25/29; B42D 25/40

(52) U.S. Cl. CPC B42D 25/324; B42D 25/40; B42D 25/29

(57) ABSTRACT

A security element includes a substantially flat substrate having a surface defining a basic plane, and a micro relief structure on the substrate comprising a plurality of micro relief structure elements, wherein each micro relief structure element comprises an element surface, and a color-generating nanostructure is located at each element surface. The color-generating nanostructure comprises a plurality of nano-projections or nano-recesses, wherein the nano-projections or nano-recesses are arranged according to a two-dimensional arrangement, wherein a nearest neighboring distance exists between the centers of neighboring nano-projections or nano-recesses. The nano-projections or nano-recesses are distributed non-periodically in the arrangement over the respective element surface, the nearest neighbor distance varies non-periodically over the respective element surface, wherein an average of the nearest neighbour distance is in a range from 170 nm to 600 nm, and a gap exists between all neighboring nano-projections or nano-recesses.

### BACKGROUND

The invention relates to a security element for protecting security papers, valuable documents or other valuables. The security element comprises a substantially flat substrate having a surface, a micro relief structure on the substrate including a plurality of micro relief structure elements, and a nanostructure comprising a plurality nano-projections or nano-recesses two-dimensionally arranged on the micro relief structure elements.

For security purposes, security elements with micro relief structure arrangements are often added to security documents, which allow for an authentication of the security document to be verified and at the same time increase protection against counterfeiting, as they cannot be reproduced even with the most modern copying devices. Such micro relief structure arrangements are particularly suitable for forming motifs that appear three-dimensional to the observer. This is particularly the case for micro-mirror structures, i.e. Fresnel structures, which are used to simulate curved surfaces. It is also possible to arrange the micro relief structure elements in such a way that the motif exhibits dynamic effects like i.e. movement effects when the security element is tilted or rotated.

It is known that the motifs produced by the micro relief structure arrangement can be colored. This is achieved by coating the surface of the micro relief structure with a multilayer coating and/or by overlaying the micro relief structure elements with color-generating nanostructures. Known color-generating nanostructures are periodic photonic structures, i.e. they have periodically arranged projections or recesses and can be covered either with a simple metal layer or with a multilayer coating. Conventional photonic structures, such as diffraction gratings and photonic crystals require periodicity of the projections or the recesses to create constructive interference and structural colors. Disorder within such structures is therefore considered as a defect, as local variations in the periodicity of these photonic structures induce scattering and decrease the brightness/saturation of the structural colors produced.

Fully disordered structures are typically used to create white colors, as these scatter all wavelengths of light. Such structures are not able to produce a structural color.

It is, therefore, an object of the invention to provide a security element, a valuable document and a method for manufacturing a security element comprising an enhanced optical effect, especially by decreased iridescence, minimized grating effects and greater defect tolerance.

### SUMMARY

The invention provides a security element for protecting security papers, valuable documents and other valuables. The security element comprises a substantially flat substrate having a surface. A plane surface defines a basic plane for the purposes of this application. The substrate can be optical transparent or semi-transparent and can be a polymer substrate or a polymer composite substrate. The polymer substrate is preferably made out of polyethylene terephthalate (PET), or out of polyethylene (PE), polypropylene (PP), polyvinyl chloride (PVC), polystyrene (PS), polyester like polycarbonate (PC), cellophane, polyactide (PLA), celluloseacetat or other common polymer types. Polymer substrates are preferred because they are resistant against external (for example physical or chemical) factors.

Onto the surface of the substrate, a micro relief structure including a plurality of micro relief structure elements is applied. Each micro relief structure element comprises an element surface. In the micro relief structure, the micro relief structure elements can be arranged in any way, they can be ordered or disordered, periodic or aperiodic. Preferably, the micro relief structure is a micro-mirror arrangement including a plurality of directionally reflecting micro-mirrors. The micro-mirrors in particular form a periodic or aperiodic sawtooth lattice. Preferably, the micro-mirrors having a linear dimension of between 2 μm and 100 μm, preferably between 5 μm and 50 μm. In particular, the micro-mirrors can have a triangular, square, rectangular, hexagonal or other polygonal base. The height of the micro-mirrors is preferably less than 15 μm, preferably less than 10 μm. In embodiments, the micro-mirrors are oriented at random in the micro-mirror arrangement. They can be oriented in at least two different directions to create viewing angle dependent effects.

To provide the substrate with a micro-mirror arrangement, a dielectric layer is applied to the surface of the substrate, which has a micro-facet arrangement as a structure for the micro-mirror arrangement. The dielectric layer is preferably provided with the desired micro-facet arrangement by embossing an embossing varnish. The embossing varnish can be transparent or colored. The micro-facet arrangement comprises several micro-facets, each of which is individually invisible to the unarmed eye of an observer. The lateral extent of a micro-facet is preferably smaller than 50 μm, so that individual micro-facets of a motif cannot be resolved by the unarmed eye of an observer. However, the micro-facets are preferably larger than 2 μm in order to minimize light diffraction at the boundary of adjacent micro-facets. It is preferable for a micro-facet to have a lateral dimension from 3 μm to 10 μm. A reflective layer is applied to the micro-facet arrangement in the dielectric layer so that they form the micro-mirror arrangement together. A preferred arrangement of micro-facets in the micro-facet arrangement is a Fresnel structure. After coating with the reflective layer, the micro-mirror arrangement preferably also has the form of a Fresnel structure.

Further, the micro relief structure elements comprise a color-generating nanostructure which is located at the element surfaces, preferably at each of them. The color-generating nanostructure comprises a plurality nano-projections or nano-recesses which are arranged according to a two-dimensional arrangement. Generally, the color-generating nanostructure is located on the element surfaces, i.e. on the surface of the above mentioned micro-facets, which means below the reflective layer, but the color-generating nanostructure can also be located above the reflective layer. The two-dimensional arrangement of the nano-projections or the nano-recesses at each of the element surfaces is non-periodic, wherein a nearest neighbour distance exists between the centres of neighbouring nano-projections or nano-recesses, which varies non-periodically over the respective element surface and a gap exists between all neighbouring nano-projections or nano-recesses. Hence, none of the nano-projections or nano-recesses abut to another, which means that the nearest neighbour distance is in any case larger than zero.

An average of the nearest neighbour distances over the respective element surface is in an average value range from 170 nm to 600 nm, preferably from 230 nm to 450 nm. This average value of the nearest neighbour distances over the respective element surface corresponds to an average pitch value Pav for the purposes of this disclosure. There can be smaller and larger nearest neighbour distances between some neighbouring nano-projections or nano-recesses, as long as the average pitch value is within the above-mentioned range. Preferably, a mathematical distribution of a count of the nearest neighbour distances over the respective element surface varies in the shape of a Gauß-distribution, a Normal distribution, a Poisson-distribution, or a Schulz-Flory distribution.

The gap between neighbouring nano-projections or nano-recesses varies non-periodically over the respective element surface in a gap range from 50 nm to 380 nm, preferably from 100 nm to 350 nm, most preferably from 120 nm to 300 nm. The nearest neighbour distance should be in a range from 170 nm to 600 nm. Because of that, gaps of different sizes within the gap range are provided on each of the respective element surfaces. By changing the gap size within the gap range, the color generated by the color-generating nanostructure can be adapted.

Because of the average pitch value Pav in a range from 170 nm to 600 nm, preferably between 230 nm and 450 nm, optical effects, especially color-effects are generated. The average pitch value Pav, and therefore the color generated by the color-generating nanostructure can be adapted by varying at least some of the nearest neighbour distances between the nano-projections or the nano-recesses on the respective element surface.

Additionally, or alternatively, the gap range, and therefore the color generated by the color-generating nanostructure can be adapted by varying a diameter of at least some of the nano-projections or the nano-recesses. In embodiments, a maximum diameter of the nano-projections or the nano-recesses is in a diameter range from 80 nm to 400 nm, preferably in a diameter range from 100 nm to 300 nm. It is possible that the diameter of the nano-projections or the nano-recesses varies over the respective element surface, which means that some diameters of nano-projections or nano-recesses on the element surface differ from other diameters of other nano-projections or nano-recesses on the element surface. This influences the color generated by the nanostructure as well but leads to a color loss. To enhance the optical effect, the diameter of the nano-projections or nano-recesses are kept constant and only the distribution of the points is varied. Hence, the color-generating nanostructure is a subwavelength structure.

The color-generating nanostructure is applied in a so called “correlated disorder”, which is a seemingly random photonic structure, but which produces structural colors. A hidden order within the structures enables coherent scattering and interference-based colors. These color-generating nanostructures arranged in correlated disorder are characterized by a reduced iridescence, minimized grating effects and greater defect tolerance. The disordered nature of these nanostructures make them harder to define than their ordered counterparts, which periodically repeat a consistent unit cell and possess translational symmetry. The color-generating nanostructures arranged in correlated disorder therefore enhance protection against counterfeiting. Nanostructures arranged in correlated disorder help attenuate grating effects in reflective structures and decrease the iridescence of plasmonic color filters whilst maintaining color saturation. Using color-generating nanostructures arranged in correlated disorder create color whilst minimizing diffraction effects and thus minimizing iridescence. Hence, color-generating nanostructures improve the optical effect of the security element.

By arranging the nano-projections and the nano-recesses in correlated disorder, the nano-projections and the nano-recesses remain a certain distance away from each other. The nano-projections and the nano-recesses have a random distribution, but a desired average pitch value, which is the average value of the nearest neighbour distances on one element surface, within the above mentioned range. The arrangement of the nano-projections and the nano-recesses is randomized to minimize the grating effect. Elements of order are introduced into the correlated disorder arrangement of the nano-projections and the nano-recesses to maximize their brightness whilst minimizing the grating effects and therefore generating an attractive color effect.

Color-generating nanostructures with a correlated disorder can be produced using a variety of algorithms, such as the two algorithms described below. The above mentioned gaps, the nearest neighbour distances and the average pitch values are created using these algorithms.

In a first algorithm, the color-generating nanostructure comprising nano-projections or nano-recesses arranged in correlated disorder are generated by an algorithm using a random placement of the nano-projections or the nano-recesses and an exclusion zone. In this algorithm, the nano-projections or the nano-recesses are placed at random, for example based on a random function from python. However, a single exclusionary feature was added to the code, which ensures that no nano-projections or nano-recesses are able to touch. Furthermore, the nano-projections or the nano-recesses are kept at a constant size. Preferably, the optical effect of the color-generating nanostructures is enhanced by reducing the variation of the gaps between neighbouring nano-projections or nano-recesses by forcing the nano-projections or the nano-recesses to maintain a set minimum distance to their neighbouring nano-projections or nano-recesses.

A second algorithm works in the same way as the first algorithm, but the optical effect of the color-generating nanostructures is enhanced by reducing the variation of the gaps between neighbouring nano-projections or nano-recesses by forcing the nano-projections or the nano-recesses to maintain a set minimum distance to their neighbouring nano-projections or nano-recesses and a certain number of predefined nano-projections or nano-recesses is kept at a constant distance to their neighbouring nano-projections or nano-recesses.

In a third algorithm, the color-generating nanostructure comprising nano-projections or nano-recesses arranged in correlated disorder are generated by an algorithm using hyperuniform based arrangements of nano-projections or nano-recesses. In a first step, an initial point is randomly placed within an area on the micro-mirror. In a second step, new candidate points are then created around the existing points at a distance between (P) and (2P), where P is a predefined period. In a third step, the candidate points are then ensured to be at least (P) distance away from all existing points and in a fourth step, steps two and three are repeated until no more valid points can be added. Hyperuniform assemblies are defined by their density fluctuations being suppressed at large scales. These have been found to enhance absorption of solar cells when compared to ordered assemblies. These hyperuniform assemblies provide greater colors than fully disordered assemblies. It is understood that the placement of the points corresponds to the placement of the nano-projections or the nano-recesses on the micro-mirror.

It is noted that a large number of other methods can be utilized to create correlated disorder.

Preferably, the color-generating nanostructure comprises at least two sub-areas which are visible to the naked eye of an observer, and which differ at least partially in colors when viewed in reflected light. The different colors of the sub-areas are preferably achieved by a different design of the color-generating nanostructure in the two sub-areas. The nearest neighbour distance n, the gap g, the diameter d and/or the height h of the color-generating nanostructure can be varied from sub-region to sub-region to create different color effects.

The micro relief structure comprises a reflective layer. Preferably, the reflective layer comprises at least a metal layer and/or a dielectric layer. Most preferably, the reflective layer is an interference layer stack comprising at least two metal layers separated by a dielectric layer. In embodiments, the described layer stack has a semi-transparent metal layer, a metallic mirror layer underneath and a dielectric layer spaced in between. Because of this layer structure only parts of the incident light spectrum are reflected, so that the reflection of white light appears colored to an observer. The perceived color depends on the angle of incidence of the light rays. Due to its multilayer structure, such a color-shift structure offers the observer a different image impression at different viewing angles and, for example, shows a different color or brightness depending on the viewing angle.

Preferably, the interference layer stack is a thin film structure with the individual layers having a thickness in micro-or nanometer range. The layers are preferably applied by means of physical vapor deposition (PVD) or chemical vapor deposition (CVD). The reflective layer has a maximum thickness of 20 μm, preferably 10 μm, highly preferably 2 μm, and has preferably a symmetrical structure in its stack of layers. The layer stack preferably comprises the following layer sequence: absorber/dielectric material/reflector/dielectric material/absorber; absorber/dielectric material/magnetic reflector/dielectric material/absorber; absorber/dielectric material/reflector/magnet/reflector/dielectric material/absorber; absorber/dielectric material/absorber. The absorber, the reflector and/or the magnetic reflector comprise Cr, Ti, Cu, Ni, Al, Si, Ge, Ga, Fe, Co, Mn, Mg, Zn, Sn, V, Ag, or alloys thereof. The dielectric layer comprises MgF2, SiO2, TiO2, ZnS, Al2O3, ZnO, ZrO2 or Sn2O3. Highly preferably the dielectric layer comprises SiO2.

The micro relief structure provided with the above described color-generating nanostructure is preferably suitable for the color design of security features for security documents, such as banknotes, ID cards or cards for payment transactions. These micro-mirror arrangements can be used, for example, to produce motifs that also have a three-dimensional appearance and/or a color tilting effect. They are particularly suitable as human features that are visible to the unarmed eye of an external observer. They can be arranged side by side with known structures such as holograms, periodical nanostructures, moth-eye structures, micro-cavities and micro-lens arrays. In particular, they can be directly adjacent to such structures, as the described micro-mirror arrangements provided with the color-generating nanostructure are embossed directly into the dielectric layer and are thus produced with a very high positional accuracy—a significantly higher positional accuracy is achieved than with known printing processes. In addition, several different embossing structures and thus several different security features can be produced in a single embossing step, which significantly reduces the manufacturing effort and thus the manufacturing costs of the security element.

Preferably, the optically variable security element is a foil element, such as a security thread, a security tape or a security patch. It can then be easily applied to a security document as a transfer element. The foil element can also be equipped with other functional layers, e.g. machine-readable magnetic coding, UV luminescence, phosphorescence, infrared coding or similar.

It is although provided a value document, such as a banknote, a cheque, a credit or other payment card, an identity card or the like, with the described optically variable security element. It is understood that the value document can be modified in the same ways as described for the optically variable security element. Here, it is equally possible to apply the described dielectric layer directly to the security document or the substrate body of the security document.

The invention further provides a method for manufacturing a security element for protecting security papers, valuable documents or other valuables, the security element comprising the following steps: Providing a substantially flat substrate having a surface defining a basic plane, applying a micro relief structure on the substrate including a plurality of micro relief structure elements, wherein each micro relied structure element comprises an element surface, and applying a color-generating nanostructure, which is located at each of the element surfaces and comprises a plurality nano-projections or nano-recesses. The nano-projections or nano-recesses are arranged according to a two-dimensional arrangement, wherein a nearest neighbour distance exists between the centres of neighbouring nano-projections or nano-recesses. The two-dimensionally arrangement of the nano-projections or the nano-recesses is non-periodically over the respective element surface, wherein the nearest neighbour distance between the centres of neighbouring nano-projections or nano-recesses varies non-periodically over the respective element surface, wherein an average of the nearest neighbour distances is in a range from 200 nm to 500 nm, and a gap exists between all neighbouring nano-projections or nano-recesses.

It is understood that the method can be modified in the same way as described for the security element.

### BRIEF DESCRIPTION OF THE DRAWINGS

In the following, embodiments of the invention are described with reference to enclosed drawings, which drawings also may disclose the inventive features. These embodiments serve explanatory purposes only and should not limit the invention. If embodiments comprise a particular combination of elements or components, the description should not be constructed that all of these elements or components are essential to the invention. Other embodiments can, rather, comprise alternative elements or components, less elements or components or additional elements or components.

FIG. 1 shows a schematic cross-sectional view of a security element;

FIG. 2 shows a periodic nanostructure in top view;

FIG. 3 shows the periodic nanostructure of FIG. 2 schematically in top view;

FIG. 4 shows the structure of FIG. 3 in detail;

FIG. 5 shows an histogram of the periodic nanostructure of FIG. 2 demonstrating a distribution of nearest neighbour distances across a point distribution on one micro-mirror;

FIG. 6 shows an aperiodic color-generating nanostructure in top view;

FIG. 7 shows the aperiodic color-generating nanostructure of FIG. 6 schematically in top view;

FIG. 8 shows the structure of FIG. 7 in detail;

FIG. 9 shows an histogram of the aperiodic color-generating nanostructure of FIG. 6 demonstrating a distribution of nearest neighbour distances across a point distribution on one micro-mirror;

FIG. 10 shows a security element comprising three different areas in top view;

FIG. 11 shows an histogram of one area of FIG. 10, demonstrating a distribution of nearest neighbour distances across a point distribution in the area; and

FIG. 12 shows an array of k-sphere images.

### DETAILED DESCRIPTION OF THE INVENTION

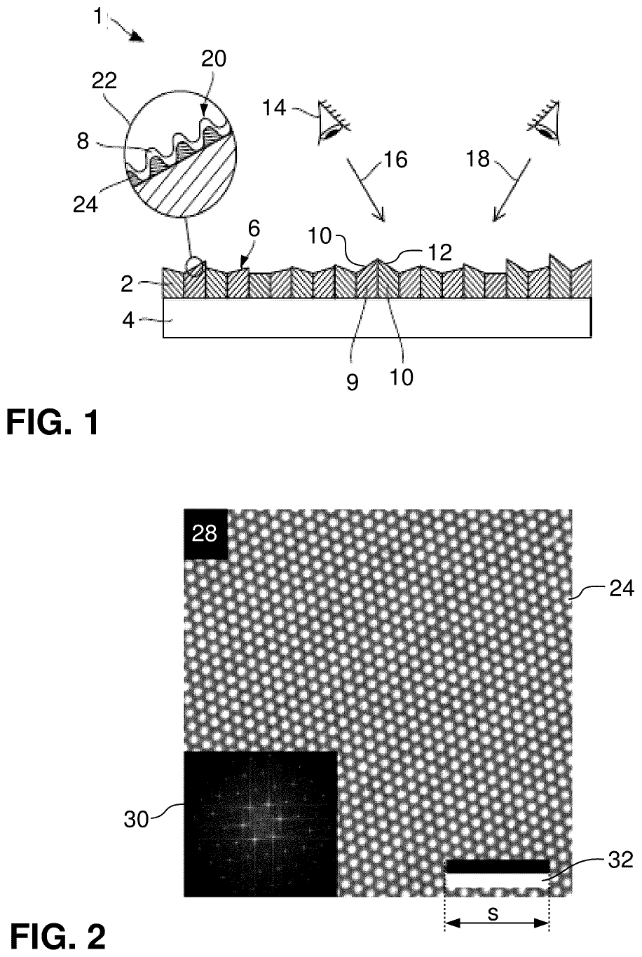

FIG. 1 shows a schematic cross-sectional view of a security element 1. A dielectric layer 2, which is i.e. an embossed lacquer layer is applied to a carrier substrate 4, in which a relief structure in the form of a micro-mirror arrangement 6 is embossed. The micromirror arrangement 6 is provided with a reflective layer 8, i.e. as coating in form of a metal layer or a multilayer film.

In this exemplary embodiment, the micro-mirror arrangement 6 contains a first group of relief structure elements 9 comprising a first element surface working as first micro-mirrors 10 and a second group of relief structure elements 11 comprising a second element surface working as second micro-mirrors 12, which are each inclined with respect to the plane of the surface of the substrate 4 in such a way that they show two different optical effects, i.e. two different three-dimensional motifs for an observer 14 from two different viewing directions 16, 18. The individual micro-mirrors 10, 12 have a lateral dimension of between 5 μm and 50 μm and thus, for example, a square base area of 10 μm×10 μm and are therefore not recognizable as such to the observer 14.

Different color effects which can be seen from the two different viewing directions 16, 18 are produced by a (full-surface) surface conformal coating of the micro-mirror arrangement 6 with the reflective layer 8 and an overlay of the micro-mirrors 10, 12 with a color-generating nanostructure 20, which is a subwavelength structure. This color-generating nanostructure 20 is shown in a first detail 22 in FIG. 1. The color-generating nanostructure 20 comprises a plurality of projections 24. These projections 24 are arranged non-periodically. For the sake of less complexity, we further talk about projections 24, but the same disclosures are also true for recesses. The modulation of the micro-mirror arrangement 6 with the coated color-generating nanostructure 20 is only shown in the first detail 22, while the sawtooth profile of the micro-mirror arrangement 6 can be recognized in the profile shown without magnification.

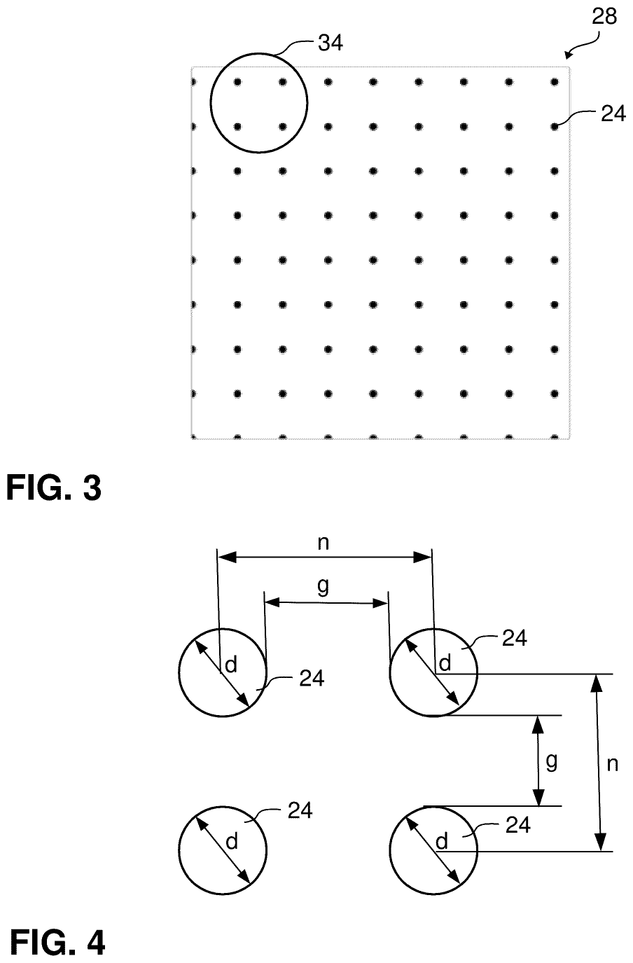

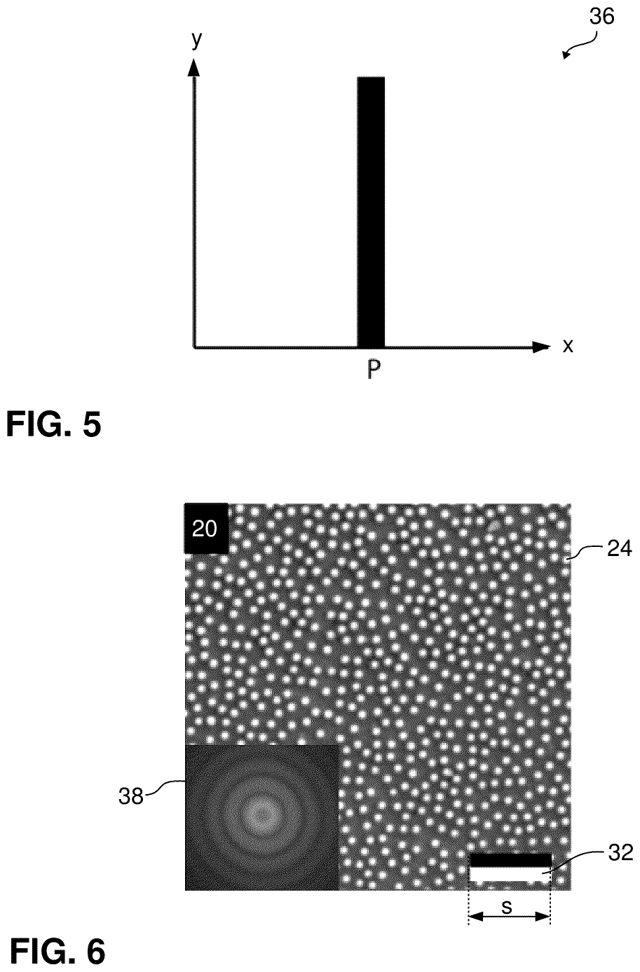

FIG. 2 shows a periodic nanostructure 28 in top view, which could be provided on the micro-mirrors 10, 12, which means on the element surface of the relief structure elements 9, 11, instead of the aperiodic color-generating nanostructure 20. The periodic nanostructure 28 comprises projections 24 (or recesses). A first optical effect 30 of this periodic nanostructure 28 is shown in the bottom left corner and a scale bar 32 with a scale bar value s of 2 μm is shown in the bottom right corner. This periodic nanostructure 28 is schematically shown in top view in FIG. 3 and in a second detail 34 in FIG. 4. FIG. 5 shows a distribution of nearest neighbour distances n across a point distribution on the respective micro-mirror 10, 12, on which the periodic nanostructure 28 is provided, in a first histogram 36.

As it can be seen in FIG. 4 in the first detail 22, the periodic nanostructure 28 comprises the plurality of projections 24 (or recesses) which are regularly arranged. The neighbouring projections 24 are spaced apart at a nearest neighbour distance n, which is the same for each neighbouring projection 24 on the respective micro-mirror 10, 12, on which the periodic nanostructure 28 is applied. The periodic nanostructure 28 is arranged in a periodic lattice wherein a pitch value corresponds to the nearest neighbor distance n which corresponds in case of this periodic nanostructure 28 to a period P, which is the distance between the centres of the neighbouring projections 24.

This is explicitly shown in FIG. 5 in the first histogram 36 in which a count (y-axis) of the projections 24 at one micro-mirror 10, 12, which is a periodic lattice is shown above the nearest neighbour distance n (x-axis) of the projections 24. One can see that the nearest neighbour distance n between each of the projections 24 on the micro-mirror 10, 12 is equal and corresponds to the period P of the periodic nanostructure 28.

FIG. 6 shows the color-generating nanostructure 20 as shown in FIG. 1, provided on the micro-mirrors 10, 12 of the security element 1 in top view. The color-generating nanostructure 20 comprises non-periodically arranged projections 24 (or recesses). A second optical effect 38 of this structure is shown in the bottom left corner and the scale bar 32 with the scale bar value s of 2 μm is shown in the bottom right corner.

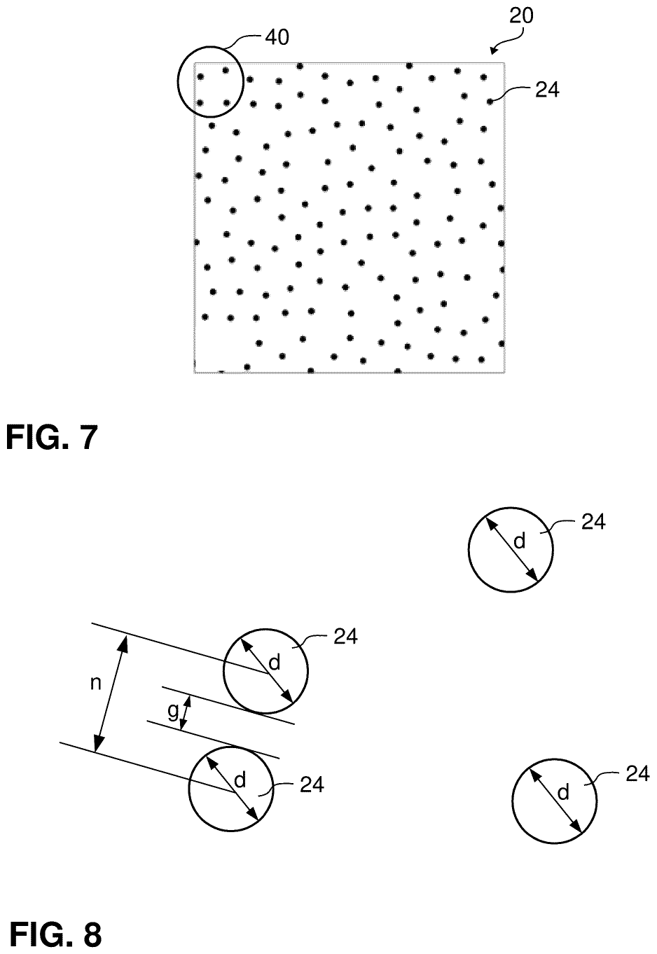

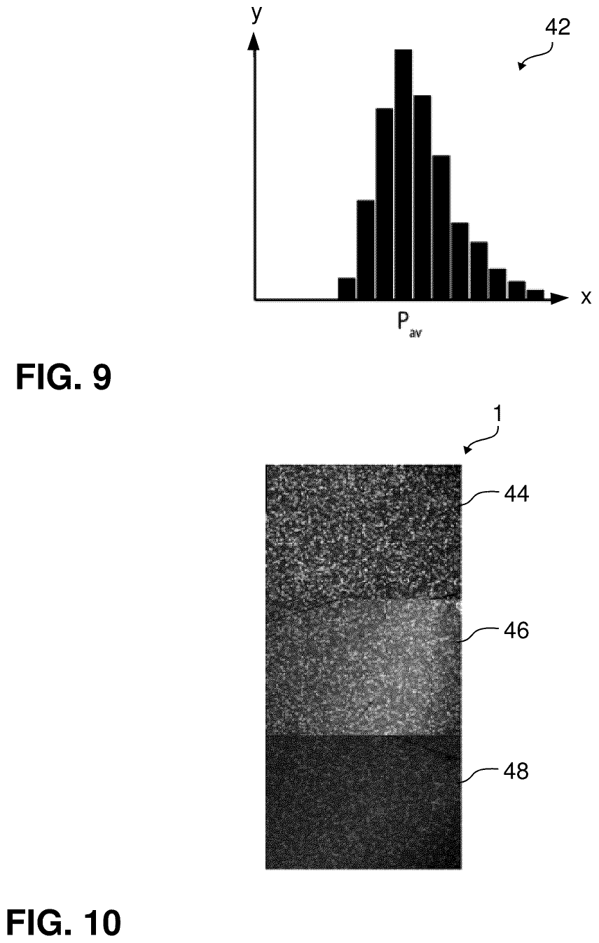

This non-periodically arranged color-generating nanostructure 20 is schematically shown in top view in FIG. 7 and in a third detail 40 in FIG. 8. FIG. 9 shows a distribution of nearest neighbour distances n across the point distribution on the respective micro-mirror 10, 12, in which the color-generating nanostructure 20 is provided, in a second histogram 42.

As it can be seen in FIG. 8 in the third detail 40, the color-generating nanostructure 20 comprises a plurality of projections 24 (or recesses) which are irregularly arranged, which means that at least some of the projections 24 differ in their nearest neighbour distance n. In the color-generating nanostructure 20, shown in FIG. 6, at least some of the neighbouring projections 24 differ in their nearest neighbour distance n and therefore gaps g between the projections 24 differ as well. The gaps g vary on the respective micro-mirror 10, 12. As it can be seen from FIG. 6 to 8, the non-periodically arranged color-generating nanostructure 20 is isotropic and does not possess periodicity. The projections 24 are arranged in correlated disorder. Therefore, these color-generating nanostructures 20 are capable of producing structural colors.

A second histogram 42 of this correlated disorder is explicitly shown in FIG. 9 in which a count (y-axis) of the projections 24 on the micro-mirror 10, 12 is shown above the nearest neighbour distance n (x-axis) of the projections 24. One can see that the nearest neighbour distance n between the projections 24 on the micro-mirror 10, 12 varies and therefore the color-generating nanostructure 20 is arranged non-periodically. Even if the color-generating nanostructure 20 is non-periodically, an average pitch value Pav is within an average pitch value range from 170 nm to 600 nm. The average pitch value Pav corresponds to an average of the nearest neighbour distances n on the respective micro-mirror 10, 12. This average pitch value Pav is shown in FIG. 9. As it can be seen in the second histogram 42, a mathematical distribution of the nearest neighbour distances n on the micro-mirror 10, 12 varies in the shape of a Gauß-distribution. Alternatively, a Normal distribution, a Poisson-distribution, or a Schulz-Flory distribution would be possible as well. Some nearest neighbour distances n are above the average pitch value Pav and some are below, but the average of the nearest neighbour distances remains within the above-mentioned range.

In case of samples with correlated disorder, there is no fixed period on the respective micro-mirror 10, 12, and the distance between neighbouring projections 24 (or recesses), the so called nearest neighbour distance n, varies. However, within this distribution in correlated disorder, the projections 24 can cluster around an average value of the nearest neighbour distances n (average pitch value Pav) for the assembly. Varying this average pitch value Pav in the color-generating nanostructure 20, a distribution of the projections 24 within the color-generating nanostructure 20, varies, which allows for color tuning to be achieved. The projections 24 can be distributed using a variety of algorithms, as long as they maintain an isotropic point distribution and an average pitch value Pav within the optical length scales.

The above mentioned color tuning is shown in FIG. 10. It is shown a security element 1 in top view comprising three areas (first area 44, second area 46 and third area 48) with color-generating nanostructures 20 differing in at least one of their gaps g, their average pitch value Pav, their diameter d or their height h of the projections 24. In the first area 44, the color-generating nanostructure 20 shows a yellowish color. In the second area 46, the color-generating nanostructure 20 shows a darker, reddish color and in the third area 48, the color-generating nanostructure 20 shows a darker, blueish color. This color tuning is achieved by changing the diameter d of some of the projections 24 (or recesses) and/or changing the gap size g between neighbouring projections 24 (or recesses) and/or changing the height h of neighbouring projections 24 (or recesses). In this case, the diameter d of the projections 24 is changed, which automatically changes the gaps g between the projections 24.

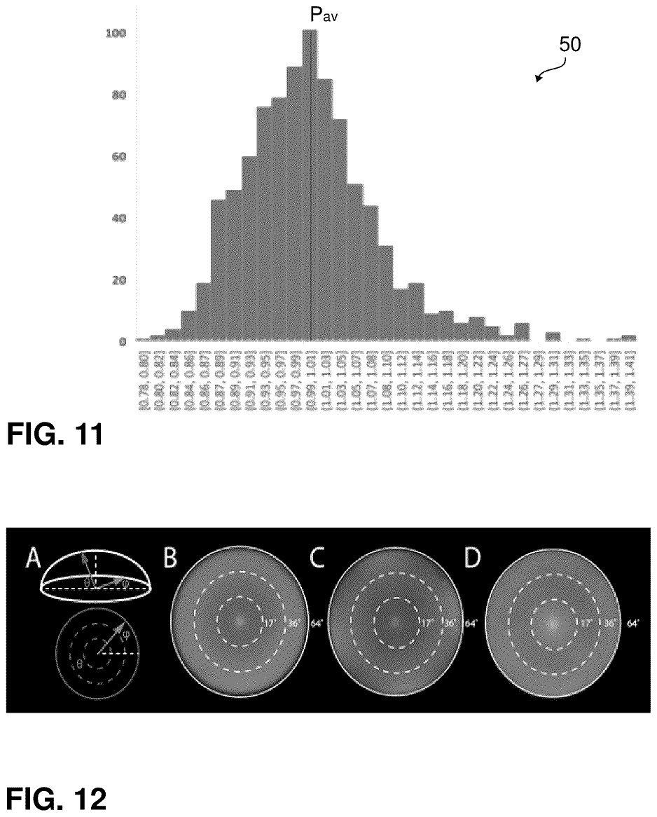

FIG. 11 shows a third histogram 50 of the distribution in the first area 44 in which a count (y-axis) of the projections 24 in the first area 44 is shown above the nearest neighbour distance n (x-axis) of the projections 24. The same histogram would correspond to the other two areas 46, 48 as well, as the same code was used to create the color-generating nanostructures 20. One can see that the nearest neighbour distance n between the projections 24 in this area vary. The third histogram 50 demonstrates the nearest neighbour distance n distribution for samples possessing correlated disorder and shows an average pitch value Pav of the first area 44.

FIG. 12 shows a schematic demonstrating k-sphere images taken from three different arrangements of color-shift coated color-generating nanostructures 20. The color scattering effect is dependent of the structure type of the projections 24. FIG. 12 shows in part A a schematic demonstrating an angular dependence of the k-space hemispherical projections 24, in part B a k-space image of a quasiordered arrangement with a magenta color, in part C a k-space image of a square arrangement with a magenta color and in part D a k-space image of a hexagonal arrangement with a magenta color.

To demonstrate the effect of order on iridescence, k-space sphere images were taken from 3 different arrangements of color shift coated plasmonic nanopillar structures in FIG. 12. These images demonstrate how these structures reflect light on a hemispherical projection when visualized from a top. In part A, the location of the angles φ and θ are demonstrated in a representative hemispherical schematic. The quasiordered structures do show some iridescence when the angle θ is varied, shifting from magenta colors towards a pale blue. This pale blue is similar to that seen from the color shift coating. However, these quasiordered structures do not vary in color when the φ is varied, and their color is therefore considered isotropic. On the other hand, the square (part C) and hexagonal (part D) specimen show variations in color when both φ and θ are varied. These effects are likely due to the periodic arrangements of the structure and vary from yellow, orange, red and blue when viewed at different angles.

1. A security element for protecting security papers, valuable documents or other valuables, the security element comprising:
a substantially flat substrate having a surface defining a basic plane;
a micro relief structure on the substrate including a plurality of micro relief structure elements;
wherein each micro relief structure element comprises an element surface, wherein a color-generating nanostructure is located at each of the element surfaces, and
the color-generating nanostructure comprises a plurality of nano-projections or nano-recesses, wherein the nano-projections or nano-recesses are arranged according to a two-dimensional arrangement, wherein a nearest neighbour distance (n) exists between the centers of neighboring nano-projections or nano-recesses;
wherein the nano-projections or nano-recesses are distributed non-periodically in the arrangement over the respective element surface;
wherein the nearest neighbor distance (n) varies non-periodically over the respective element surface, wherein an average of the nearest neighbour distance (n) is in a range from 170 nm to 600 nm; and
wherein a gap (g) exists between all neighboring nano-projections or nano-recesses.

2. The security element as claimed in claim 1, wherein the average of the nearest neighbor distance (n) is in a range from 230 nm to 450 nm.

3. The security element as claimed in claim 1, wherein the gap (g) between neighbouring nano-projections or nano-recesses varies non-periodically over the respective element surface in a gap range from 50 nm to 380 nm.

4. The security element as claimed in claim 1, wherein a maximum diameter (d) of the nano-projections or the nano-recesses is in a diameter range from 80 nm to 400 nm.

5. The security element as claimed in claim 4, wherein the diameter (d) of the nano-projections or the nano-recesses varies over the respective element surface.

6. The security element as claimed in claim 1, wherein a maximum height (h) of each nano-projection or nano-recess is in a height range from 50 nm to 400 nm.

7. The security element as claimed in claim 6, wherein the height (h) of the nano-projections or the nano-recesses varies over the respective element surface.

8. The security element as claimed in claim 1, wherein none of the nano-projections or the nano-recesses abut to another.

9. The security element as claimed in claim 1, wherein a mathematical distribution of the nearest neighbour distances (n) over the respective element surface varies in the shape of a Gauß-distribution, a Normal distribution, a Poisson-distribution, or a Schulz Flory distribution.

10. The security element as claimed in claim 1, wherein a reflective layer is provided on the micro relief structure and comprises at least a metal layer and/or a dielectric layer.

11. The security element as claimed in claim 1, wherein the reflective layer is a color-shift layer comprising at least two metal layers separated by a dielectric layer.

12. The security element as claimed in claim 1, wherein the micro relief structure is a micro-mirror structure including a plurality of micro-mirrors.

13. The valuable document comprising a security element as claimed in claim 1.

14. A method for manufacturing a security element for protecting security papers, valuable documents or other valuables, the security element comprising the following steps:
providing a substantially flat substrate having a surface defining a basic plane;
applying a micro relief structure on the substrate including a plurality of micro relief structure elements;
wherein each micro relief structure element comprises an element surface, and applying a color-generating nanostructure which is located at each of the element surfaces, the color-generating nanostructure comprises a plurality nano-projections or nano-recesses, wherein the nano-projections or nano-recesses are arranged according to a two-dimensional arrangement, wherein a nearest neighbour distance (n) exists between the centers of neighboring nano-projections or nano-recesses;
wherein the nano-projections or nano-recesses are distributed non-periodically in the arrangement over the respective element surface;
wherein the nearest neighbor distance (n) varies non-periodically over the respective element surface, wherein an average of the nearest neighbour distance (n) is in a range from 170 nm to 600 nm; and
wherein a gap (g) exists between all neighbouring nano-projections or nano-recesses.
